(19) United States
(12) Patent Application Publication
(10) Pub. No.: US 2012/0116034 A1
(43) Pub. Date: May 10, 2012

(54) SOLUTION POLYMERIZATION PROCESS AND PROCATALYST CARRIER SYSTEMS USEFUL THEREIN

(75) Inventors: Thomas Oswald, Lake Jackson, TX (US); Ian M. Munro, Houston, TX (US)

(73) Assignee: DOW GLOBAL TECHNOLOGIES, INC., Midland, MI (US)

(21) Appl. No.: 12/941,297

(22) Filed: Nov. 8, 2010

(51) Int. Cl. C08F 4/76; C08F 4/52; B01J 31/14; C08F 4/42

(52) U.S. Cl. 526/170; 526/183; 526/189; 502/117

(57) ABSTRACT

A procatalyst carrier system which includes one or more paraffinic solvents, one or more paraffin-insoluble procatalysts, and optionally one or more cocatalysts wherein the carrier system is in the form of a slurry is provided. Also provided is a process including selecting one or more paraffin-insoluble organometallic procatalysts; adding the one or more procatalysts to a sufficient quantity of paraffinic solvent to form a slurry of the one or more procatalysts in the paraffinic solvent; introducing one or more first cocatalysts into a polymerization reactor; and introducing the slurry into the polymerization reactor; a reaction product of the process and articles made from the reaction product.

### FIELD OF INVENTION

The instant invention relates to a solution polymerization process and procatalyst carrier systems useful therein.

### BACKGROUND OF THE INVENTION

Certain organometallic polymerization procatalysts useful for the polymerization of olefins are not significantly soluble in paraffinic solvents. Thus, for use in solution polymerization reactors, such catalysts have heretofore been dissolved in aromatic solvents prior to introduction into the solution polymerization reactor.

Specific organometallic procatalysts are capable of producing very high molecular weight resins with substantial long chain branching, such as those procatalysts disclosed in Published Applications WO2007/136497, WO2007/136506, WO2007/136495, WO2007/136496, WO2007/136494, and U.S. 20090299116, the disclosures of which are incorporated herein by reference. Such procatalysts are more particularly useful to produce resins with a very high molecular weight first components with a very high level of long chain branching and a second polymer component with a high melt index, such as those resins described in co-pending U.S. patent application Ser. No. 12/608,647, the disclosure of which is incorporated herein by reference. Such resins are particularly useful in extrusion coating applications, requiring low levels of low density polyethylene. Such procatalysts are also useful in solution reactors. Some such procatalysts, however, are insoluble in paraffinic solvents, necessitating dissolution in aromatic solvents such as toluene, for use in solution reactors. Polymers produced in the presence of such aromatic solvents are generally not acceptable for food contact use.

A procatalyst carrier system which may be used to produce polymers, and particularly, food contact grade resins, and which may optionally be used in a solution reactor system would therefore be desirable.

### SUMMARY OF THE INVENTION

A first aspect of the invention provides a procatalyst carrier system comprising one or more paraffinic solvents, one or more paraffin-insoluble procatalysts, and optionally one or more cocatalysts wherein the carrier system is in the form of a slurry.

Another aspect of the invention provides a process comprising: selecting one or more paraffin-insoluble organometallic procatalysts; adding the one or more procatalysts to a sufficient quantity of paraffinic solvent to form a slurry of the one or more procatalysts in the paraffinic solvent; optionally, introducing one or more first cocatalysts into the polymerization reactor; and introducing the slurry into a polymerization reactor.

In an alternative embodiment, the instant invention provides a procatalyst carrier system and method of producing the same, except that, the one or more paraffin-insoluble procatalysts are selected from the group of transition metal organometallic compounds which catalyze the polymerization of olefins in the presence of a cocatalyst; biphenylphenol complexes of titanium, zirconium or hafnium; pyridylamine complexes of titanium, zirconium or hafnium; metallocene complexes of titanium, zirconium or hafnium; imine and phenolimine complexes of titanium, zirconium or hafnium; and combinations thereof.

In an alternative embodiment, the instant invention provides a procatalyst carrier system and method of producing the same, except that, the one or more paraffin-insoluble procatalysts are selected from the group of compounds according to the following formula:

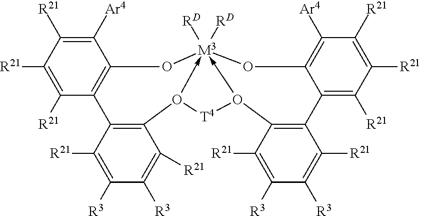

wherein M³ is Ti, Hf or Zr, preferably Zr; Ar⁴ independently each occurrence is a substituted C₉₋₂₀ aryl group, wherein the substituents, independently each occurrence, are selected from the group consisting of alkyl; cycloalkyl; and aryl groups; and halo-, trihydrocarbylsilyl- and halohydrocarbyl-substituted derivatives thereof, with the proviso that at least one substituent lacks co-planarity with the aryl group to which it is attached; T⁴ independently each occurrence is a C₂₋₂₀ alkylene, cycloalkylene or cycloalkenylene group, or an inertly substituted derivative thereof; R²¹ independently each occurrence is hydrogen, halo, hydrocarbyl, trihydrocarbylsilyl, trihydrocarbylsilylhydrocarbyl, alkoxy or di(hydrocarbyl)amino group of up to 50 atoms not counting hydrogen; R³ independently each occurrence is hydrogen, halo, hydrocarbyl, trihydrocarbylsilyl, trihydrocarbylsilylhydrocarbyl, alkoxy or amino of up to 50 atoms not counting hydrogen, or two R³ groups on the same arylene ring together or an R³ and an R²¹ group on the same or different arylene ring together form a divalent ligand group attached to the arylene group in two positions or join two different arylene rings together; and R^{D}, independently each occurrence is halo or a hydrocarbyl or trihydrocarbylsilyl group of up to 20 atoms not counting hydrogen, or 2 R^{D} groups together are a hydrocarbylene, hydrocarbadiyl, diene, or poly(hydrocarbyl)silylene group.

In an alternative embodiment, the instant invention provides a procatalyst carrier system and method of producing the same, except that, the one or more paraffin-insoluble procatalysts are selected from the group of

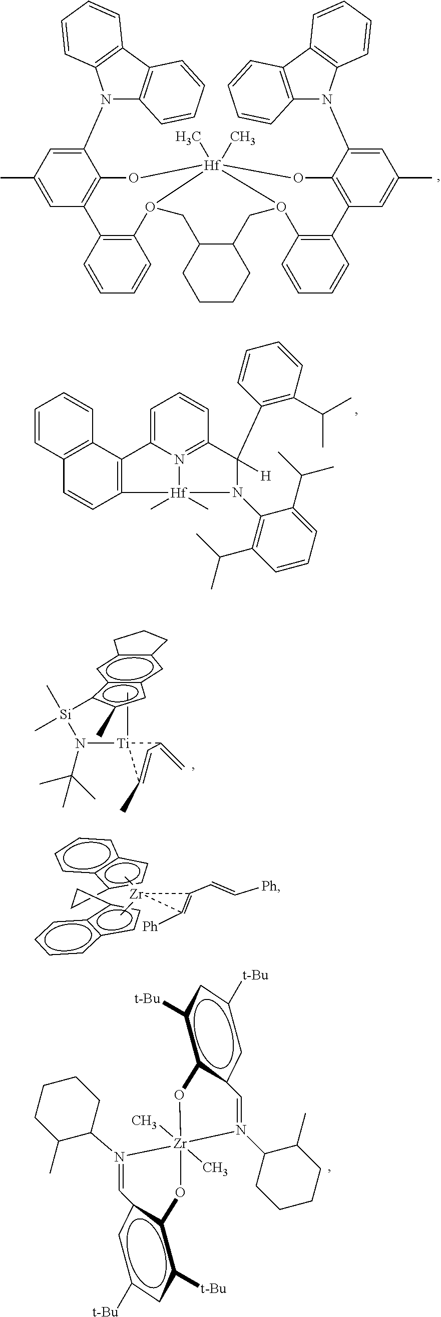

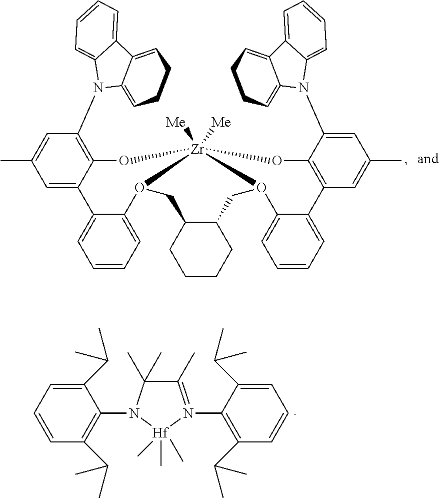

In yet another embodiment of the inventive procatalyst carrier system, the one or more paraffin-insoluble procatalysts comprises the compound depicted by:

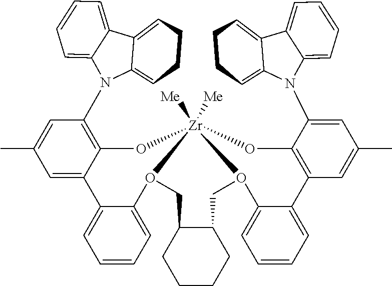

In an alternative embodiment, the instant invention provides a procatalyst carrier system and method of producing the same, except that, the one or more cocatalysts are selected from the from group of modified methyl, isobutyl aluminoxane (MMAO) and bis(hydrogenated tallowalkyl)methylammonium tetrakis(pentafluorophenyl)borate.

In an alternative embodiment, the instant invention provides a procatalyst carrier system and method of producing the same, except that, the inventive procatalyst carrier system further comprises one or more scavengers.

In an alternative embodiment, the instant invention provides a procatalyst carrier system and method of producing the same, except that, the one or more organometallic procatalysts are selected from the group of transition metal organometallic compounds which catalyze the polymerization of olefins in the presence of a cocatalyst; biphenylphenol complexes of titanium, zirconium or hafnium; pyridylamine complexes of titanium, zirconium or hafnium; metallocene complexes of titanium, zirconium or hafnium; imine and phenolimine complexes of titanium, zirconium or hafnium; and combinations thereof.

In an alternative embodiment, the instant invention provides a procatalyst carrier system and method of producing the same, except that, the paraffinic solvent is selected from the group of normal alkanes, iso-alkanes, and combinations thereof which are liquids at the temperatures and pressures of a procatalyst preparation and delivery system.

In an alternative embodiment, the instant invention provides a procatalyst carrier system and method of producing the same, except that, the inventive process further comprises introducing one or more second cocatalysts into the procatalyst slurry prior to introducing the slurry into the polymerization reactor.

In an alternative embodiment, the instant invention provides a procatalyst carrier system and method of producing the same, except that, the inventive process further comprises introducing one or more first monomers selected from ethylene and propylene.

In an alternative embodiment, the instant invention provides a procatalyst carrier system and method of producing the same, except that, the inventive process further comprises introducing one or more C₃ to C₂₀ α-olefins into the polymerization reactor.

In an alternative embodiment, the instant invention provides a procatalyst carrier system and method of producing the same, except that, the inventive process further comprises introducing one or more dienes into the polymerization reactor.

In an alternative embodiment, the instant invention provides a procatalyst carrier system and method of producing the same, except that, the one or more first monomers is ethylene, the one or more C₃ to C₂₀ α-olefins is propylene, and the one or more dienes is ethylidenenorborene.

In an alternative embodiment, the instant invention provides a procatalyst carrier system and method of producing the same, except that, the one or more paraffin-insoluble procatalysts comprises the compound depicted by:

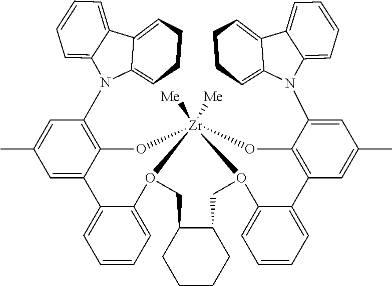

In an alternative embodiment, the instant invention provides a procatalyst carrier system and method of producing the same, except that, the one or more first cocatalysts and one or more second cocatalysts are selected from the from group of MMAO and bis(hydrogenated tallowalkyl)methylammonium tetrakis(pentafluorophenyl)borate.

In an alternative embodiment, the instant invention provides a procatalyst carrier system and method of producing the same, except that, the polymerization reactor is a solution reactor.

In an alternative embodiment, the instant invention provides a procatalyst carrier system and method of producing the same, except that, the one or more paraffin-insoluble procatalyst is selected from the group of compounds according to the following formula:

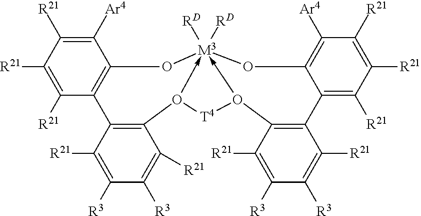

wherein M³ is Ti, Hf or Zr, preferably Zr; Ar⁴ independently each occurrence is a substituted C₉₋₂₀ aryl group, wherein the substituents, independently each occurrence, are selected from the group consisting of alkyl; cycloalkyl; and aryl groups; and halo-, trihydrocarbylsilyl- and halohydrocarbyl-substituted derivatives thereof, with the proviso that at least one substituent lacks co-planarity with the aryl group to which it is attached; T⁴ independently each occurrence is a C₂₋₂₀ alkylene, cycloalkylene or cycloalkenylene group, or an inertly substituted derivative thereof; R²¹ independently each occurrence is hydrogen, halo, hydrocarbyl, trihydrocarbylsilyl, trihydrocarbylsilylhydrocarbyl, alkoxy or di(hydrocarbyl)amino group of up to 50 atoms not counting hydrogen; R³ independently each occurrence is hydrogen, halo, hydrocarbyl, trihydrocarbylsilyl, trihydrocarbylsilylhydrocarbyl, alkoxy or amino of up to 50 atoms not counting hydrogen, or two R³ groups on the same arylene ring together or an R³ and an R²¹ group on the same or different arylene ring together form a divalent ligand group attached to the arylene group in two positions or join two different arylene rings together; and R^{D}, independently each occurrence is halo or a hydrocarbyl or trihydrocarbylsilyl group of up to 20 atoms not counting hydrogen, or 2 R^{D} groups together are a hydrocarbylene, hydrocarbadiyl, diene, or poly(hydrocarbyl)silylene group.

In an alternative embodiment, the instant invention provides a procatalyst carrier system and method of producing the same, except that, the one or more paraffin-insoluble organometallic procatalysts is selected from the group of

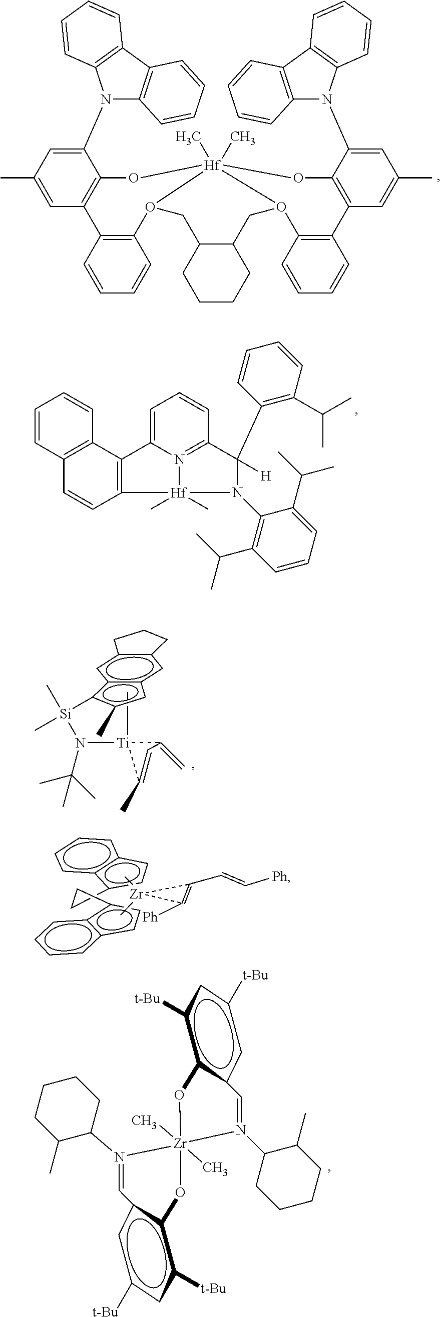

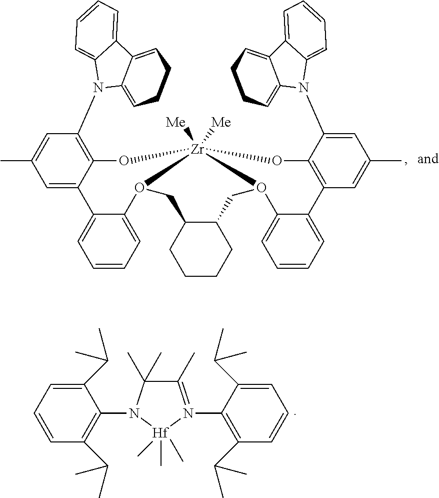

Yet another embodiment of the invention provides a reaction product of any one or any combination of the foregoing embodiments of the inventive process. In certain specific embodiments the reaction product is an EPDM.

Yet another embodiment of the invention provides an article produced from any one or any combination of two or more of the foregoing embodiments of the inventive reaction products of the inventive process.

Yet another embodiment of the invention provides a procatalyst carrier system consisting essentially of one or more paraffinic solvents, one or more paraffin-insoluble procatalysts, and optionally one or more cocatalysts wherein the carrier system is in the form of a slurry.

Yet another aspect of the invention provides a process consisting essentially of: selecting one or more paraffin-insoluble organometallic procatalysts; adding the one or more procatalysts to a sufficient quantity of paraffinic solvent to form a slurry of the one or more procatalysts in the paraffinic solvent; optionally, introducing one or more first cocatalysts into the polymerization reactor; optionally introducing one or more scavengers into the polymerization reactor; introducing the slurry into a polymerization reactor; introducing one or more olefin monomers into the polymerization reactor; and recovering one or more products from the polymerization reactor.

### BRIEF DESCRIPTION OF THE FIGURES

For the purpose of illustrating the invention, there is shown in the drawings a form that is exemplary; it being understood, however, that this invention is not limited to the precise arrangements and instrumentalities shown.

FIG. 1 depicts the GPC-RI chromatograms of the LLDPE polymers made in Inventive Example 1 and Comparative Example 2;

FIG. 2 depicts the GPC-RI chromatograms of the EPDM polymers made in Inventive Example 2 and Comparative Example 2; and

FIG. 3 depicts the viscosity of EPDM polymers made in Inventive Example 2 and Comparative Example 2.

### DETAILED DESCRIPTION

The term “paraffin-insoluble” in reference to a compound means that the compound forms a solution in a paraffinic solvent at levels of 0.005 wt % or less compound based on the weight of the paraffinic solvent at temperatures and pressures extant in a procatalyst slurry preparation and delivery system.

The term “paraffinic solvent” means a solvent comprising normal and/or branched alkanes wherein the paraffinic solvent contains less than 100 ppm by weight total aromatic compounds, such as benzene and toluene, and which is liquid at room temperatures. Paraffinic solvents include, for example, mineral oil grades meeting the aromatic compound limitation and ISOPAR™ E, which is an isoparaffinic liquid having less than 5 ppm benzene and which is available from Exxon Mobil Corporation.

The term “procatalyst” means an organometallic compound that attains ability to catalyze a polymerization reaction when activated by reaction with a cocatalyst in the presence of monomer.

The term “cocatalyst” means a compound that reacts with the pro-catalyst in the presence of monomer to yield a catalytically active species. The term “activator” may be used synonymously with the term “cocatalyst.”

The term “scavenger” means a compound or group of compounds added to a polymerization reactor system to react with or otherwise remove unwanted chemical species in the reactor system that would, in the absence of the scavenger, interfere with the catalytic polymerization resulting in reduced rate of production of the desired polymer. In some instances, the cocatalyst and scavenger may be the same compound wherein a stoichiometric excess of cocatalyst acts as a scavenger. An example of a cocatalyst that also acts as a scavenger is MMAO.

The term “solution process” means, in the process of manufacturing a polymer, the catalyzed polymerization reaction takes place in the solution phase, in which all monomers and catalyst and growing polymer entities exist as dissolved species in a reaction solvent.

The term “reaction solvent” means a hydrocarbon used to dissolve all reacting species in the manufacture of polymer. The hydrocarbon exists in the liquid phase at the temperatures and pressures extant in the polymerization reactor system.

The invention is a solution polymerization process and a procatalyst carrier system for use therein.

The procatalyst carrier system of the invention comprises one or more paraffinic solvents, one or more paraffin-insoluble procatalysts, and optionally, one or more cocatalysts wherein the carrier system is in the form of a slurry.

The one or more paraffin-insoluble procatalysts useful in the invention include paraffin-insoluble members of the group of transition metal organometallic compounds which catalyze the polymerization of olefins in the presence of a cocatalyst; biphenylphenol complexes of titanium, zirconium or hafnium; pyridylamine complexes of titanium, zirconium or hafnium; metallocene complexes of titanium, zirconium or hafnium; imine and phenolimine complexes of titanium, zirconium or hathium; and combinations thereof. Certain of those catalysts of the foregoing groups which are useful in the invention include paraffin-insoluble metal complexes of a polyvalent aryloxyether as shown by the following:

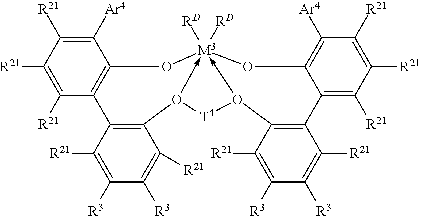

where M³ is Ti, Hf or Zr, preferably Zr;

Ar⁴ independently each occurrence is a substituted C₉₋₂₀ aryl group, wherein the substituents, independently each occurrence, are selected from the group consisting of alkyl; cycloalkyl; and aryl groups; and halo-, trihydrocarbylsilyl- and halohydrocarbyl-substituted derivatives thereof, with the proviso that at least one substituent lacks co-planarity with the aryl group to which it is attached;

T⁴ independently each occurrence is a C₂₋₂₀ alkylene, cycloalkylene or cycloalkenylene group, or an inertly substituted derivative thereof;

R²¹ independently each occurrence is hydrogen, halo, hydrocarbyl, trihydrocarbylsilyl, trihydrocarbylsilylhydrocarbyl, alkoxy or di(hydrocarbyl)amino group of up to 50 atoms not counting hydrogen;

R³ independently each occurrence is hydrogen, halo, hydrocarbyl, trihydrocarbylsilyl, trihydrocarbylsilylhydrocarbyl, alkoxy or amino of up to 50 atoms not counting hydrogen, or two R³ groups on the same arylene ring together or an R³ and an R²¹ group on the same or different arylene ring together form a divalent ligand group attached to the arylene group in two positions or join two different arylene rings together; and

R^{D}, independently each occurrence is halo or a hydrocarbyl or trihydrocarbylsilyl group of up to 20 atoms not counting hydrogen, or 2 R^{D} groups together are a hydrocarbylene, hydrocarbadiyl, diene, or poly(hydrocarbyl)silylene group.

Other paraffin-insoluble procatalysts useful in the invention include those organometallic compounds depicted by the following formulas:

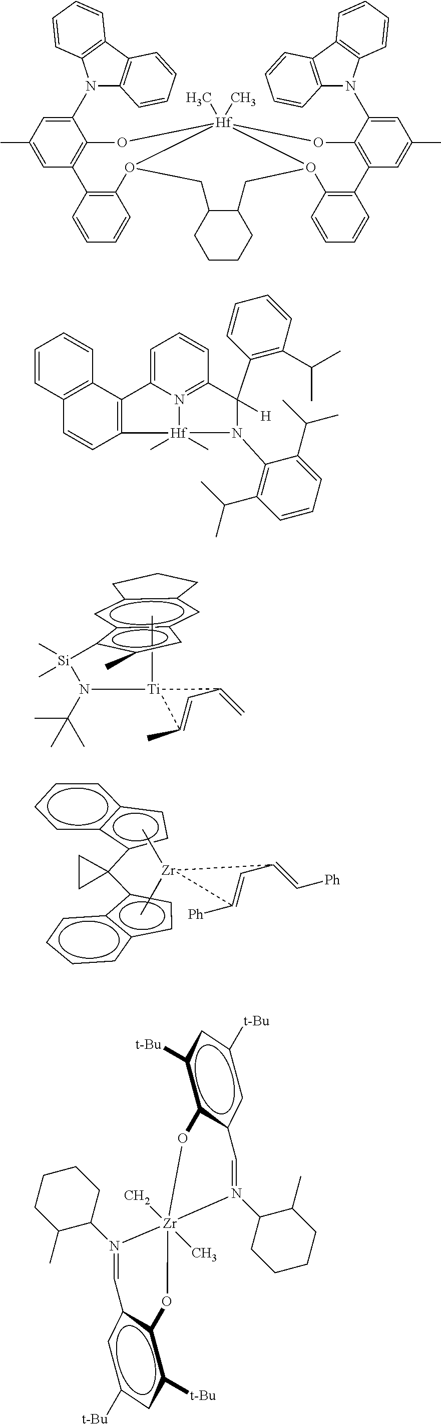

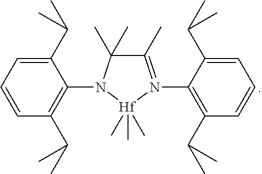

Additional paraffin-insoluble procatalysts useful in the invention are disclosed in and may be prepared according to the processes disclosed in U.S. Pat. Nos. 7,312,283; 7,368,411; 7,119,155; 7,300,903; and U.S. Patent Publication No. 20090299116 and Published Applications WO2007/136497, WO2007/136506, WO2007/136495, WO2007/136496, and WO2007/136494 the disclosures of which are incorporated herein in its entirety.

Some embodiments of the invention utilize the procatalysts disclosed in U.S. Pat. No. 7,399,874, the disclosure of which is disclosed herein by reference. Alternative embodiments of the invention exclude the procatalysts disclosed in U.S. Pat. No. 7,399,874.

In some embodiments, paraffin-insoluble procatalysts useful in the invention may be supported on inorganic materials, such as silica, such as those procatalysts described in U.S. Pat. Nos. 7,169,864; 7,220,804; 7,449,533; 6,331,601; 6,469,936 and 5,308,815, the disclosures of which are incorporated herein by reference.

In preferred embodiments of the invention, the paraffin-insoluble procatalysts are not supported on inorganic materials.

The one or more paraffinic solvents useful in various embodiments of the inventive procatalyst carrier system include normal alkanes, branched alkanes, or iso-alkanes, or combinations thereof which are liquids at those temperatures and pressures extant in the procatalyst preparation and delivery systems. Exemplary paraffinic solvents useful in the invention include C₅₋₁₂ normal alkanes, ISOPARTME, available from Exxon Mobil Corporation, mineral oil, and mixtures thereof. Paraffinic solvents useful in some embodiments of the invention have a kinematic viscosity of less than 140 cSt at 40° C. (measured according to ASTM D445). All values of less than 140 cSt are disclosed and included herein. For example, useful paraffinic solvents may have a kinematic viscosity of less than 140 cSt; alternatively, less than 130 cSt; alternatively, less than 120 cSt; alternatively, less than 110 cSt; alternatively, less than 100 cSt; or alternatively, less than 100 cSt.

In those embodiments of the inventive procatalyst carrier system which include one or more cocatalysts, the one or more cocatalysts may be selected from aluminoxanes and aluminum alkyls, including, for example, those disclosed in U.S. Pat. Nos. 7,247,594; 5,919,983; and 6,121,185, the disclosures of which are incorporated herein by reference. In certain embodiments, the one or more cocatalysts is MMAO. In other particular embodiments, the cocatalyst is bis(hydrogenated tallowalkyl)methylammonium tetrakis(pentafluorophenyl)borate. The one or more cocatalysts may be paraffin-insoluble or alternatively, may be soluble in paraffinic solvents.

In some embodiments, one or more aluminoxanes are used as cocatalysts. Aluminoxanes are generally oligomeric compounds containing —Al(R¹)—O— sub-units, where R¹ is an alkyl group. Examples of aluminoxanes include methylaluminoxane (MAO), modified methylaluminoxane (MMAO), ethylaluminoxane and isobutylaluminoxane. Alkylaluminoxanes and modified alkylaluminoxanes are suitable as cocatalysts, particularly when the abstractable ligand is a halide, alkoxide or amide. Mixtures of different aluminoxanes and modified aluminoxanes may also be used.

In some embodiments, the one or more cocatalysts are represented by the following general formulae: (R³—Al—O)ₚ; and R⁴(R⁵—Al—O)p-AlR⁶₂. An aluminoxane may be a mixture of both the linear and cyclic compounds. In the foregoing aluminoxane formulae, R³, R⁴, R⁵ and R⁶ are, independently a C1-C30 alkyl radical, for example, methyl, ethyl, propyl, butyl, pentyl, hexyl, heptyl, octyl, nonyl, decyl, and “p” is an integer from 1 to about 50. Most preferably, R³, R⁴, R⁵ and R⁶ are each methyl and “p” is a least 4. When an alkyl aluminum halide or alkoxide is employed in the preparation of the aluminoxane, one or more R³⁻⁶ groups may be halide or alkoxide. Additional cocatalysts and methods for producing them are disclosed for example in U.S. Pat. No. 7,399,874.

In some embodiments of the invention, the procatalyst carrier system further comprises one or more scavengers. Suitable scavengers useful in the invention may be selected from aluminoxanes and aluminum alkyls, including, for example those disclosed in U.S. Pat. Nos. 7,399,874; 7,247,594; 5,919,983; and 6,121,185. MMAO may be used, in some embodiments, as a scavenger, or alternatively, as both a cocatalyst and scavenger, when present in a stoichiometric excess. The one or more scavengers may be paraffin-insoluble or alternatively, may be soluble in paraffinic solvents.

Because the procatalysts useful in the invention are paraffin-insoluble, the inventive procatalyst carrier system is in the form of a slurry, wherein the procatalyst particles are suspended in the one or more paraffinic solvents. In preferred embodiments, the inventive procatalyst carrier system is a homogeneous slurry. The homogeneity of the slurry procatalyst carrier system may be achieved by mechanical agitation or other means, such as non-laminar flow, and may be maintained by the viscosity of the paraffinic solvent, continued agitation, or a combination thereof.

The process of the invention comprises: selecting one or more paraffin-insoluble organometallic procatalysts; adding the one or more procatalysts to a sufficient quantity of paraffinic solvent to form a slurry of the one or more procatalysts in the paraffinic solvent; introducing one or more first cocatalysts into a polymerization reactor; and introducing the slurry into the polymerization reactor.

The paraffin-insoluble organometallic procatalysts and cocatalysts useful in the inventive process are as described herein.

The inventive process may further comprise introducing one or more first monomers selected from ethylene and propylene. The inventive process may further comprise introducing one or more C₃ to C₂₀ α-olefins into the polymerization reactor. The inventive process may further comprise introducing one or more dienes into the polymerization reactor. In a preferred embodiment, the inventive process further comprises introducing ethylene, propylene, and ethylidenenorborene into the polymerization reactor.

The polymerization reactor useful in the inventive process may be any polymerization reactor suitable for polymerizing olefins and for the introduction of a slurry, including such polymerization systems in which the solvent of the slurry may be vaporized upon or following introduction into the polymerization reactor. Such polymerization reactors are described, for example, in U.S. Pat. No. 5,272,236; the disclosure of which is incorporated herein by reference.

In the inventive process, the paraffin-insoluble procatalyst is added to the reactor as a slurry. In various embodiments of the inventive process, the procatalyst slurry is added to the polymerization reactor as a separate feed stream from the feed stream containing the one or more cocatalysts; or alternatively, in a joint stream with the one or more cocatalysts.

In some embodiments of the inventive process, one or more scavengers are also introduced into the polymerization reactor. The one or more cocatalysts may be added to the polymerization reactor as a separate feed stream from the feed stream containing the one or more scavengers; or alternatively, in a joint stream with the one or more scavengers. Likewise, the procatalyst slurry may be added to the polymerization reactor as a separate feed stream from the feed stream containing the one or more scavengers; or alternatively, in a joint stream with the one or more scavengers. Likewise, the procatalyst slurry, one or more cocatalysts and one or more scavengers may be introduced into the polymerization reactor in a combined feed stream.

The one or more cocatalysts may be added to the polymerization reactor in the form of a solution or slurry. The carrying medium for the one or more cocatalysts may be one or more paraffinic solvents wherein the carrying mediums are miscible with the reaction solvent.

The one or more scavengers may be added to the polymerization reactor in the form of a solution or slurry. The carrying medium for the one or more scavengers may be one or more paraffinic solvents wherein the carrying mediums are miscible with the reaction solvent.

Reaction solvents useful in embodiments of the inventive process include paraffinic solvents, such as for example, ISOPAR™ E, n-hexane, n-octane or combinations thereof.

In preferred embodiments of the inventive process, the procatalyst slurry is homogenized, separate from the one or more cocatalysts and scavengers, prior to introduction into the polymerization reactor. In certain preferred embodiments, the homogeneity of the procatalyst slurry is maintained during introduction into the polymerization reactor.

Another aspect of the invention is the reaction product of the inventive process. Reaction products include for example, linear low density polyethylene (LLDPE) and ethylene-propylene-diene terpolymers (EPDM).

The invention further includes articles made partially or wholly from one or more reaction products of the inventive process. Such articles include, for example, blown films made by the single or double bubble process, and cast films. Alternatively, the reaction product of the inventive process may be used to produce films applied as part of an extrusion coating process or lamination process and further modified by such processes as corona treatment and or any biaxial stretch method, such as stretched in a tenter frame. The reaction products of the inventive process may also be used to produce articles by injection molding or blow molding processes and/or to make foams, as described, for example, in U.S. Pat. Nos. 6,723,79; 6,583,222; 6,583,188; 6,54,509; and 6,395,79, the disclosures of which are incorporated herein by reference. The reaction products of the inventive process may be further used to produce thermoformed articles.

### EXAMPLES

The following examples illustrate the present invention but are not intended to limit the scope of the invention. The inventive examples demonstrate that use of the inventive catalyst carrier system achieves polymerization with essentially no change in catalyst activity or polymer formed in comparison to the use of procatalyst solutions formed with aromatic solvents.

### Test Methods

### CEF Method

Comonomer distribution analysis was performed with Crystallization Elution Fractionation (“CEF”). Ortho-dichlorobenzene (“ODCB”) with 600 ppm by weight antioxidant, specifically tert-butylated hydroxytoluene (“BHT”), was used as the solvent. Sample preparation was effected using an autosampler at 160° C. for 2 hours under shaking at 4 mg/ml (unless otherwise specified). The injection volume was 300 μl. The temperature profile of CEF was: crystallization at 3° C./minute from 110° C. to 30° C.; followed by thermal equilibration at 30° C. for 5 minutes, and subsequent elution at 3° C./minute from 30° C. to 140° C. The flow rate during crystallization was 0.052 ml/minute. The flow rate during elution was 0.50 ml/minute. The data was collected at one data point/second.

The CEF column was a ⅛ inch stainless steel tube packed with acid washed glass beads having a diameter of 125 microns (±6%), available from MO-SCI Specialty Products. The column volume was 2.06 ml. The column temperature calibration was performed using a mixture of NIST Standard Reference Material linear polyethylene 1475a (1.0mg/ml) and eicosane (2 mg/ml) in ODCB. The temperature was calibrated by adjusting the elution heating rate so that the NIST linear polyethylene 1475a had a peak temperature at 101.0° C., and eicosane had a peak temperature of 30.0° C. The CEF column resolution was calculated with a mixture of NIST linear polyethylene 1475a (1.0 mg/ml) and hexacontane (Fluka, purum, ≧97.0%, lmg/ml). A baseline separation of hexacontane and NIST polyethylene 1475a was achieved. The ratio of the area of hexacontane (from 35.0 to 67.0° C.) to the area of NIST 1475a from 67.0 to 110.0° C. was 1:1, and the amount of soluble fraction below 35.0° C. was <1.8 wt %.

The CEF column resolution as defined by Equation 1 below was 6.0.

$$Resolution = \frac{\begin{matrix}Peak temperature of NIST 1475 a - \\ Peak Temperature of Hexacontane\end{matrix}}{\begin{matrix}Half \text{-} height Width of NIST 1475 a + \\ Half \text{-} height Width of Hexacontane\end{matrix}} \qquad ( Eq . 1 )$$

### Melt Index

Melt index, I₂, was tested at 190° C. with a 2.16 kg weight according to AS™ D1238 (1999) and is reported herein as gram per 10 minutes (g/10 min).

### Dynamic Mechanical Spectroscopy (DMS) Frequency Sweep

Resin samples were compression molded into 3 mm thick×1 inch circular plaques at 350° F. for 5 minutes under 1500 psi pressure in air. The compression molded samples were removed from the press and allowed to cool at ambient temperatures in air.

A constant temperature frequency sweep was performed using an Advanced Rheometric Expansion System (“ARES”), available from TA Instruments, equipped with 25 mm parallel plates, under a nitrogen purge. The sample was placed on the plate and allowed to melt for five minutes at 190° C. The plates were then closed to 2 mm gap, the sample trimmed, and the test started following a five minute delay, to allow for temperature equilibration. The tests were performed at 190° C. over a frequency range of 0.1 to 100 rad/s. The strain amplitude was constant at 10%. The stress response was analyzed in terms of amplitude and phase, from which the storage modulus (G′), loss modulus (G″), complex modulus (G*), dynamic viscosity η*, and tan (δ) or tan (delta) were calculated.

### Conventional GPC M_{w-gpc} Determination

To obtain M_{w-gpc} values, the chromatographic system used was either a Polymer Laboratories Model PL-210™ or a Polymer Laboratories Model PL-220™. The column and carousel compartments were operated at 140° C. Three Polymer Laboratories 10-μm Mixed-B columns were used employing 1,2,4-trichlorobenzene as solvent. The samples were prepared at a concentration of 0.1 g of polymer in 50 ml of solvent. The solvent used to prepare the samples contained 200 ppm of the antioxidant butylated hydroxytoluene (BHT) (i.e., 2,6-bis(1,1-dimethylethyl)-4-methylphenol). Samples were prepared by agitating lightly for 4 hours at 160° C. The injection volume was 100 microliters and the flow rate was 1.0 ml/min. Calibration of the GPC columns was performed with twenty one narrow molecular weight distribution polystyrene standards, available from Varian, Inc. The polystyrene standard peak molecular weights were converted to polyethylene molecular weights using Equation 2:

M_{polyethylene}=A(M_{polystyrene})^{B} (Eq. 2)

where Mₓ is the molecular weight of compound x, A is 0.4316 and B is 1.0. A third order polynomial is determined to build the logarithmic molecular weight calibration as a function of elution volume. Polyethylene equivalent molecular weight calculations were performed using Viscotek TriSEC™ software Version 3.0. The precision of the weight-average molecular weight M_{w} was less than 2.6%.

### EPDM Composition

EPDM Composition was measured by FTIR as follows:
a. Ethylene content was measured according to AS™ D3900-05;
b. ENB (ethylidenenorborene) content was measured according to AS™ D6047-99; and
c. Propylene content (as % by weight) was calculated as 100 wt %−(Ethylene+ENB) where ethylene and ENB are expressed as weight percent.

### Inventive Example 1 and Comparative Example 1

The composition of the procatalyst slurry used in Inventive Example 1 is shown in Table 1 and that of the procatalyst solution used in Comparative Example 1 is shown in Table 2. Such procatalyst preparations were each used in one gallon batch polymerization reactors. The polymerization reactor conditions are given in Table 3. The polymer made in the processes of Inventive Example 1 and Comparative Example 1 were a linear low density polyethylene (“LLDPE”).

The procatalyst used in all Inventive and Comparative Examples was:

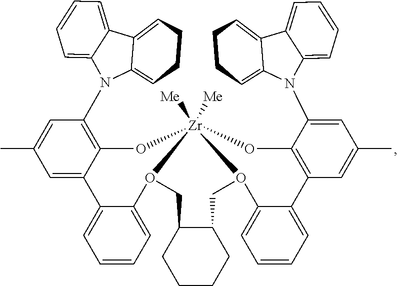

which may be made using the process described in U.S. Patent Publication No. 20090299116, the disclosure of which is incorporated herein in its entirety.

TABLE 1

| | Concentration | | |
|---|---|---|---|
| Component | (Moles/L) | Ml | Micromoles |
| Procatalyst | 0.0025 | 0.15 | 0.38 |
| Cocatalyst | 0.0030 | 0.15 | 0.45 |
| Scavenger | 0.13 | 0.15 | 18.75 |

| | |
|---|---|
| Solvent | Isopar E |

Metal ratios

| | | | |
|---|---|---|---|
| Boron:Zirconium | 1.20 | Al:Zirconium | 50.00 |

The cocatalyst used in each of Inventive Example 1 and Comparative Example 1 was bis(hydrogenated tallowalkyl)methylammonium tetrakis(pentafluorophenyl)borate which may be prepared as described in U.S. Pat. No. 5,919,983, the disclosure of which is incorporated herein by reference. The scavenger used in each of Inventive Example 1 and Comparative Example 1 was MMAO (Modified Methylaluminoxane, type 3A).

TABLE 2

| | Concentration | | |
|---|---|---|---|
| Component | (Moles/L) | Ml | Micromoles |
| Procatalyst | 0.0025 | 0.15 | 0.38 |
| Cocatalyst | 0.0030 | 0.15 | 0.45 |
| Scavenger | 0.13 | 0.15 | 18.75 |

| | |
|---|---|
| Solvent | Toluene |

Metal ratios

| | | | |
|---|---|---|---|
| Boron:Zirconium | 1.20 | Al:Zirconium | 50.00 |

TABLE 3

| | | |
|---|---|---|
| | Inventive | Comparative |
| Component | Example 1 | Example 1 |

Reactive and inert components

| | | |
|---|---|---|
| Solvent (g) | 1329.5 | 1329.7 |
| Ethylene (g) | 107.2 | 105.7 |
| Hydrogen (millimole) | 20.1 | 20.0 |
| Octene (g) | 251.4 | 251.7 |
| Max ethylene flow (g/min) | 14.6 | 17.0 |

Reactor measurements made

| | | |
|---|---|---|
| Catalyst efficiency (mass | 1102754 | 1132531 |
| polymer/mass zirconium) | | |
| Initial Pressure (psi) | 429.5 | 431.1 |
| Temperature at start (° C.) | 190.0 | 189.9 |
| Exotherm (° C.) | 6.00 | 6.30 |
| Time of reaction (min) | 10.0 | 10.0 |

In each of Inventive Example 1 and Comparative Example 1, the solvent used in batch polymerization reactor was Isopar™ E and the following procedure was followed: Solvent, Isopar E, was added to the one gallon polymerization batch reactor, followed by addition of 1-octene and hydrogen with agitation at 1000 rpm; the reactor was heated to the start temperature and ethylene was added to achieve the initial pressure; the procatalyst slurry (for Inventive Example 1) or procatalyst solution (for Comparative Example 1) was prepared under a dry nitrogen atmosphere, injected into a sample loop, and the loop contents were then pumped into the reactor with additional high pressure Isopar E. As polymerization progressed, the temperature was maintained at the Initial Temperature and the Initial Pressure was maintained by adding ethylene to the batch reactor. Polymerization was permitted to proceed for ten minutes, at which time the ethylene flow was stopped and the reactor contents were emptied into a catch pot in which most of the ethylene and solvent flashed-off. The ethylene/octene copolymers were removed from the catch pot and the residual solvent removed from the copolymers in a vacuum oven (100 C for 24 hrs). The resins obtained from for each of Inventive Example 1 and Comparative Example 1 were analyzed and the results are listed in Table 4-7.

TABLE 4

| | | |
|---|---|---|
| | Inventive | Comparative |
| Property or Parameter | Example 1 | Example 1 |

CEF Analysis

| | | |
|---|---|---|
| Mw (using light scattering at | 99133 | 97656 |
| 90 degrees detection), g/mol | | |
| Temp range for Zone #1, ° C. | 26.45-31.97 | 26.45-31.98 |
| Temp range for Zone #2, ° C. | 32.02-86.05 | 32.04-85.96 |
| Temp range for Zone #3, ° C. | 86.1-109.97 | 86.05-109.97 |
| Tp of Zone #1, ° C. | 28.8 | 28.66 |
| Tp of Zone #2, ° C. | 54.16 | 54.20 |
| Tp of Fraction #3, ° C. | 99.11 | 99.73 |
| Wt fraction of Zone #1 | 0.2865 | 0.2690 |
| Wt fraction of Zone #2 | 0.7131 | 0.7281 |
| Wt fraction of Zone #3 | 0.0004 | 0.0029 |
| Mw of Zone #1, g/mol | 60455 | 60503 |
| Mw of Zone #2, g/mol | 113825 | 111907 |
| IV of Zone #1, dl/g | 0.50 | 0.51 |
| IV of Zone #2, dl/g | 1.115 | 1.231 |

TABLE 5

| | Inventive | Comparative |
|---|---|---|
| Property or Parameter | Example 1 | Example 1 |
| Viscosity at 0.1 s⁻¹, Pa-s | 1891 | 1720 |
| Viscosity at 1.0 s⁻¹, Pa-s | 1831 | 1677 |
| Viscosity at 10 s⁻¹, Pa-s | 1450 | 1381 |
| Viscosity at 100 s⁻¹, Pa-s | 759 | 739 |

TABLE 6

| | Inventive | Comparative |
|---|---|---|
| Property | Example 1 | Example 1 |
| I₂, g/10 min | 4.65 | 4.64 |

TABLE 7

| | | |
|---|---|---|
| | Inventive | Comparative |
| Property | Example 1 | Example 1 |

GPC
Refractive Index (RI) Detector

| | | |
|---|---|---|
| Mn, g/mol | 29,480 | 28,720 |
| Mw, g/mol | 74,920 | 74,190 |
| Mz, g/mol | 149,000 | 145,100 |

Light scattering (LS) Detector

| | | |
|---|---|---|
| Mn, g/mol | 37,025 | 38,037 |
| Mw, g/mol | 90,650 | 95,590 |
| Mz, g/mol | 186,200 | 198,800 |

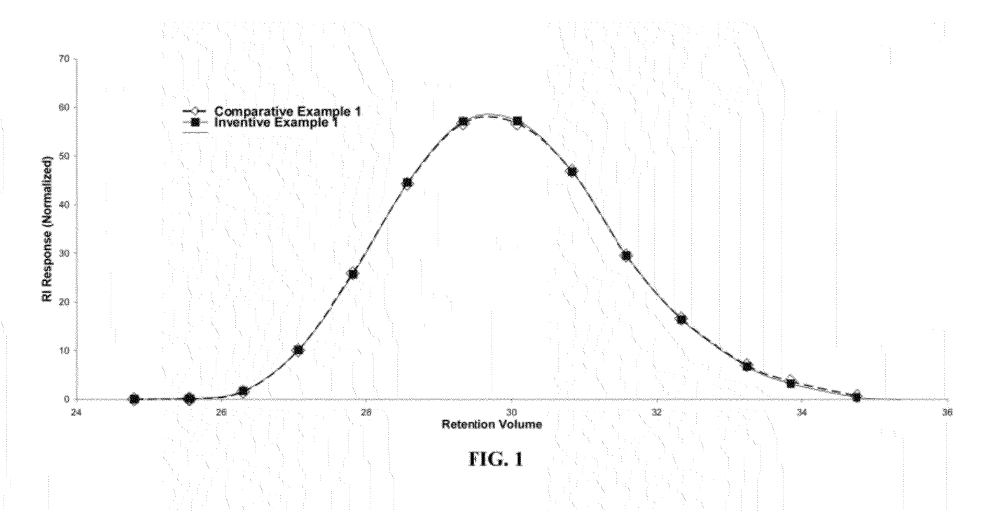

The GPC traces (RI detector) of the copolymer produced in each of Inventive Example 1 and Comparative Example 1 are shown in FIG. 1. Tables 4-7 demonstrate that the use of the inventive procatalyst slurry produces a copolymer that is very similar to copolymer produced using the comparative procatalyst solution. Moreover, nearly identical reactor kinetics using the comparative procatalyst solution and the inventive procatalyst slurry were observed.

### Inventive Example 2 and Comparative Example 2

The polymerization reactions of each of Inventive Example 2 and Comparative Example 2 were conducted in mixed reactors in a series configuration with the reactors fed with continuous flow of procatalyst and monomer feeds and with recycle streams. The procatalyst slurry used in Inventive Example 2 was prepared as follows: under dry nitrogen atmosphere, 1.0 g of procatalyst powder was slurried in 150 ml of Isopar™ E and loaded into a 200 ml stainless steel cylinder, which was flushed with 1 liter of Isopar E into a catalyst tank, which contained an additional 2 liters of Isopar E. The final slurry concentration in the catalyst tank was 320 ppm by weight of the procatalyst. The catalyst tank was agitated with a stirring impellor.

The procatalyst solution used in Comparative Example 2 was prepared as follows: the procatalyst was purchased as a 1% solution in toluene from Boulder Scientific and was further diluted, in toluene in the catalyst tank, to a concentration of 400 ppm by weight of the procatalyst.

For Inventive Example 2, the procatalyst slurry and cocatalyst solution were pumped directly from their respective tanks using metering pumps, available from Pulsafeeder, Inc., into a common feed line in which the procatalyst slurry and cocatalyst solution are mixed for 30 seconds prior to being pumped into both reactors.

For Comparative Example 2, the procatalyst and cocatalyst solutions were pumped directly from their respective feed tanks using metering pumps, available from Pulsafeeder, Inc., into a common feed line in which the procatalyst and cocatalyst solutions are mixed for 30 seconds prior to being pumped into both reactors.

Reactor feed and production rates for Inventive Example 2 and Comparative Example 2 are given in Table 8. Reactor conditions for Inventive Example 2 and Comparative Example 2 are given in Table 9. The polymer made in each of Inventive Example 2 and Comparative Example 2 was an ethylene/propylene/norbornadiene copolymer, an EPDM copolymer.

TABLE 8

| | Inventive | Comparative |
|---|---|---|
| | Example 2 | Example 2 |
| First Reactor Procatalyst Flow (lbs/hr) | 0.95 | 0.65 |
| First Reactor Procatalyst Concentration (ppm) | 7.0 | 7.0 |
| First Reactor Cocatalyst Flow (lbs/hr) | 1.25 | 0.86 |
| First Reactor Cocatalyst Concentration(ppm) | 78 | 78 |
| Second Reactor Procatalyst Concentration | 7 | 7 |
| (ppm) | | |
| Second Reactor Cocatalyst Concentration | 78 | 78 |
| (ppm) | | |
| Second Reactor Monomer Conversion (%) | 67.5 | 64.8 |
| Polymer made in First Reactor (%) | 57 | 66 |
| Production Rate (lb/Hr) | 46.8 | 45.4 |
| First Reactor Polymer (Wt %) (molten solids) | 14.6 | 17.1 |
| Second Reactor Polymer (Wt %) | 13.0 | 12.6 |
| (molten solids) | | |

TABLE 9

| | Inventive | Comparative |
|---|---|---|
| | Example 2 | Example 2 |
| First Reactor Temperature, ° C. | 141.84 | 142.42 |
| First Reactor Pressure, psig | 524.56 | 525.44 |
| First Reactor feed solvent flow, (lbs/hr) | 152.40 | 152.55 |
| First Reactor feed hydrogen flow, (standard | 739.97 | 740.45 |
| cubic centimeters per minute (SCCM)) | | |
| First Reactor ethylene flow, (lbs/hr) | 21.29 | 21.35 |
| First Reactor propylene flow, (lbs/hr) | 11.23 | 11.80 |
| First Reactor ENB flow, (lbs/hr) | 0.47 | 0.40 |
| First Reactor feed total inlet flows, (lbs/hr) | 180.20 | 179.50 |
| Second Reactor feed hydrogen flow, (SCCM) | 900.13 | 902.95 |
| Second Reactor ethylene flow, (lbs/hr) | 19.99 | 20.01 |
| Second Reactor propylene flow, (lbs/hr) | 14.00 | 11.08 |
| Second Reactor ENB flow, (lbs/hr) | 0.38 | 0.25 |
| Second Reactor total inlet flows, (lbs/hr) | 357.91 | 352.12 |
| Total Monomer Conversion, [%] | 83.20 | 82.5 |
| Second Reactor Monomer Conversion, [%] | 67.53 | 69.55 |

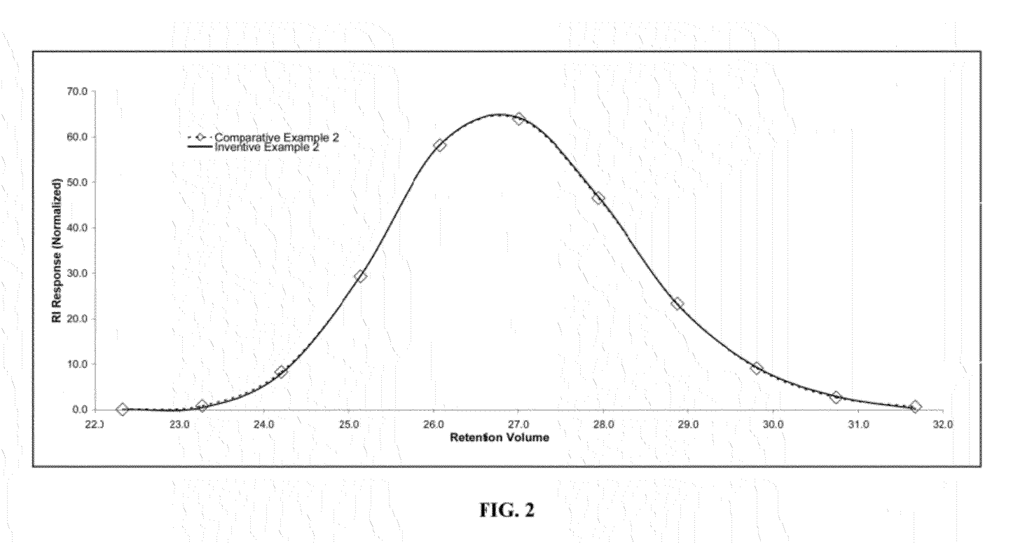

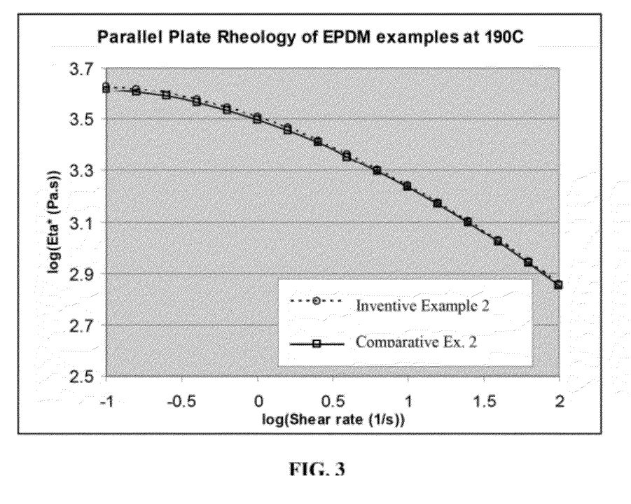

The copolymer resins obtained from Inventive Example 2 and Comparative Example 2 were analyzed and the results are given in Table 10. The GPC traces (RI detector) of the copolymer produced in each of Inventive Example 2 and Comparative Example 2 are shown in FIG. 2. DMS (Viscosity) data for Inventive Example 2 and Comparative Example 2 is shown graphically in FIG. 3.

TABLE 10

| | | |
|---|---|---|
| | Inventive | Comparative |
| Parameter | Example 2 | Example 2 |

EPDM Compositional Analysis (FTIR)

| | | |
|---|---|---|
| Ethylene, wt % | 73.5 | 72.7 |
| ENB, wt % | 1.1 | 1.1 |
| Propylene, wt % | 25.4 | 26.2 |

GPC - RI detector

| | | |
|---|---|---|
| Mn, g/mol | 26050 | 25300 |
| Mw, g/mol | 64450 | 65500 |
| Mz, g/mol | 129100 | 135100 |
| MWD | 2.47 | 2.59 |

Dynamic Mechanical Spectroscopy at 190° C.

| | | |
|---|---|---|
| Viscosity at 0.1 s⁻¹, Pa-s | 4274.35 | 4100.36 |
| Viscosity at 1.0 s⁻¹, Pa-s | 4128.87 | 4020.83 |
| Viscosity at 10 s⁻¹, Pa-s | 3961.41 | 3863.26 |
| Viscosity at 100 s⁻¹, Pa-s | 3745.67 | 3655.6 |

The present invention may be embodied in other forms without departing from the spirit and the essential attributes thereof, and, accordingly, reference should be made to the appended claims, rather than to the foregoing specification, as indicating the scope of the invention.

We claim:

1. A procatalyst carrier system comprising one or more paraffinic solvents, one or more paraffin-insoluble procatalysts, and optionally one or more cocatalysts wherein the carrier system is in the form of a slurry.

2. The procatalyst carrier system according to claim 1 wherein the one or more paraffin-insoluble procatalysts are selected from the group of transition metal organo-metallic compounds which catalyze the polymerization of olefins in the presence of a cocatalyst; biphenylphenol complexes of titanium, zirconium or hafnium; pyridylamine complexes of titanium, zirconium or hafnium; metallocene complexes of titanium, zirconium or hafnium; imine and phenolimine complexes of titanium, zirconium or hafnium; and combinations thereof

3. The procatalyst carrier system according to claim 1 wherein the one or more paraffin-insoluble procatalysts are selected from the group of compounds according to the following formula: 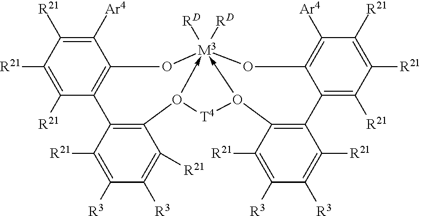
wherein M³ is Ti, Hf or Zr, preferably Zr; Ar⁴ independently each occurrence is a substituted C₉₋₂₀ aryl group, wherein the substituents, independently each occurrence, are selected from the group consisting of alkyl; cycloalkyl; and aryl groups; and halo-, trihydrocarbylsilyl- and halohydrocarbyl-substituted derivatives thereof, with the proviso that at least one substituent lacks co-planarity with the aryl group to which it is attached; T⁴ independently each occurrence is a C₂₋₂₀ alkylene, cycloalkylene or cycloalkenylene group, or an inertly substituted derivative thereof; R²¹ independently each occurrence is hydrogen, halo, hydrocarbyl, trihydrocarbylsilyl, trihydrocarbylsilylhydrocarbyl, alkoxy or di(hydrocarbyl)amino group of up to 50 atoms not counting hydrogen; R³ independently each occurrence is hydrogen, halo, hydrocarbyl, trihydrocarbylsilyl, trihydrocarbylsilylhydrocarbyl, alkoxy or amino of up to 50 atoms not counting hydrogen, or two R³ groups on the same arylene ring together or an R³ and an R²¹ group on the same or different arylene ring together form a divalent ligand group attached to the arylene group in two positions or join two different arylene rings together; and R^{D}, independently each occurrence is halo or a hydrocarbyl or trihydrocarbylsilyl group of up to 20 atoms not counting hydrogen, or 2 R^{D} groups together are a hydrocarbylene, hydrocarbadiyl, diene, or poly(hydrocarbyl)silylene group.

4. The procatalyst carrier system according to claim 1 wherein the one or more paraffin-insoluble procatalysts are selected from the group of

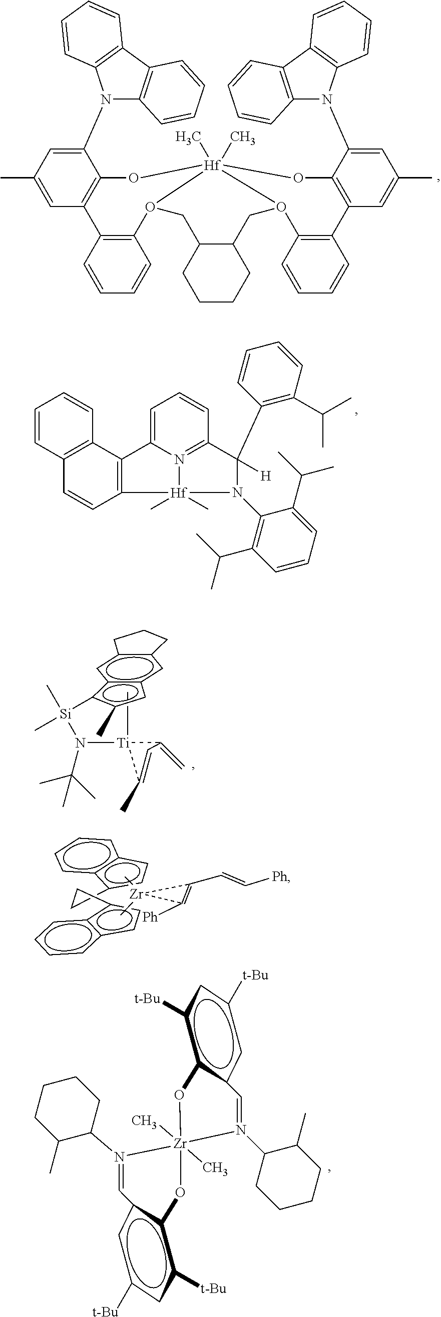

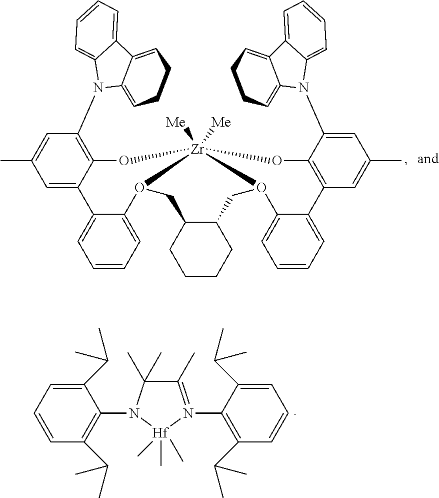

5. The procatalyst carrier system according to claim 1 wherein the one or more paraffin-insoluble procatalysts comprises the compound depicted by:

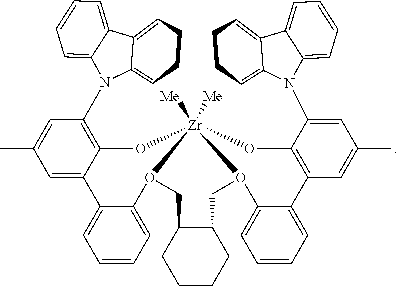

6. The procatalyst carrier system according to claim 1 wherein the one or more cocatalysts are selected from the from group of MMAO and bis(hydrogenated tallowalkyl)methylammonium tetrakis(pentafluorophenyl)borate.

7. The procatalyst carrier system according to claim 1 further comprising one or more scavengers.

8. A process comprising:
selecting one or more paraffin-insoluble organometallic procatalysts;
adding the one or more procatalysts to a sufficient quantity of paraffinic solvent to form a slurry of the one or more procatalysts in the paraffinic solvent;
introducing one or more first cocatalysts into a polymerization reactor; and
introducing the slurry into the polymerization reactor.

9. The process according to claim 8 wherein the one or more organometallic procatalysts are selected from the group of transition metal organometallic compounds which catalyze the polymerization of olefins in the presence of a cocatalyst; biphenylphenol complexes of titanium, zirconium or hafnium; pyridylamine complexes of titanium, zirconium or hafnium; metallocene complexes of titanium, zirconium or hafnium; imine and phenolimine complexes of titanium, zirconium or hafnium; and combinations thereof.

10. The process according to claim 8 wherein the paraffinic solvent is selected from the group of normal alkanes, iso-alkanes, and combinations thereof which are liquids at the temperatures and pressure extant in a procatalyst slurry preparation and delivery system.

11. The process according to claim 8 further comprising introducing one or more second cocatalysts directly into the polymerization reactor.

12. The process according to claim 8 further comprising introducing one or more first monomers selected from ethylene and propylene.

13. The process according to claim 12 further comprising introducing one or more C₃ to C₂₀ α-olefins into the polymerization reactor.

14. The process according to claim 13 further comprising introducing one or more dienes into the polymerization reactor.

15. The process according to claim 14 wherein the one or more first monomers is ethylene, the one or more C₃ to C₂₀ α-olefins is propylene, and the one or more dienes is ethylidenenorborene.

16. The process according to claim 8 wherein the one or more paraffin-insoluble procatalysts comprises the compound depicted by:

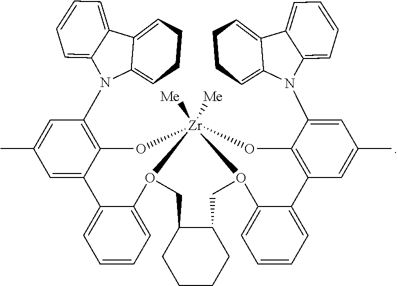

17. The process according to claim 8 wherein the one or more first cocatalysts and one or more second cocatalysts are selected from the group of MMAO and bis(hydrogenated tallowalkyl)methylammonium tetrakis(pentafluorophenyl)borate.

18. The process according to claim 8 wherein the polymerization reactor is a solution reactor.

19. The process according to claim 8 wherein the one or more paraffin-insoluble procatalyst is selected from the group of compounds according to the following formula: 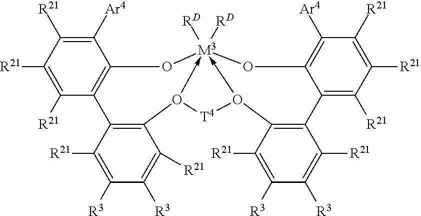
wherein M³ is Ti, Hf or Zr, preferably Zr; Ar⁴ independently each occurrence is a substituted C₉₋₂₀ aryl group, wherein the substituents, independently each occurrence, are selected from the group consisting of alkyl; cycloalkyl; and aryl groups; and halo-, trihydrocarbylsilyl- and halohydrocarbyl-substituted derivatives thereof, with the proviso that at least one substituent lacks co-planarity with the aryl group to which it is attached; T⁴ independently each occurrence is a C₂₋₂₀ alkylene, cycloalkylene or cycloalkenylene group, or an inertly substituted derivative thereof; R²¹ independently each occurrence is hydrogen, halo, hydrocarbyl, trihydrocarbylsilyl, trihydrocarbylsilylhydrocarbyl, alkoxy or di(hydrocarbyl)amino group of up to 50 atoms not counting hydrogen; R³ independently each occurrence is hydrogen, halo, hydrocarbyl, trihydrocarbylsilyl, trihydrocarbylsilylhydrocarbyl, alkoxy or amino of up to 50 atoms not counting hydrogen, or two R³ groups on the same arylene ring together or an R³ and an R²¹ group on the same or different arylene ring together form a divalent ligand group attached to the arylene group in two positions or join two different arylene rings together; and R^{D}, independently each occurrence is halo or a hydrocarbyl or trihydrocarbylsilyl group of up to 20 atoms not counting hydrogen, or 2 R^{D} groups together are a hydrocarbylene, hydrocarbadiyl, diene, or poly(hydrocarbyl)silylene group.

20. The process according to claim 8 wherein the one or more paraffin-insoluble organometallic procatalysts is selected from the group of

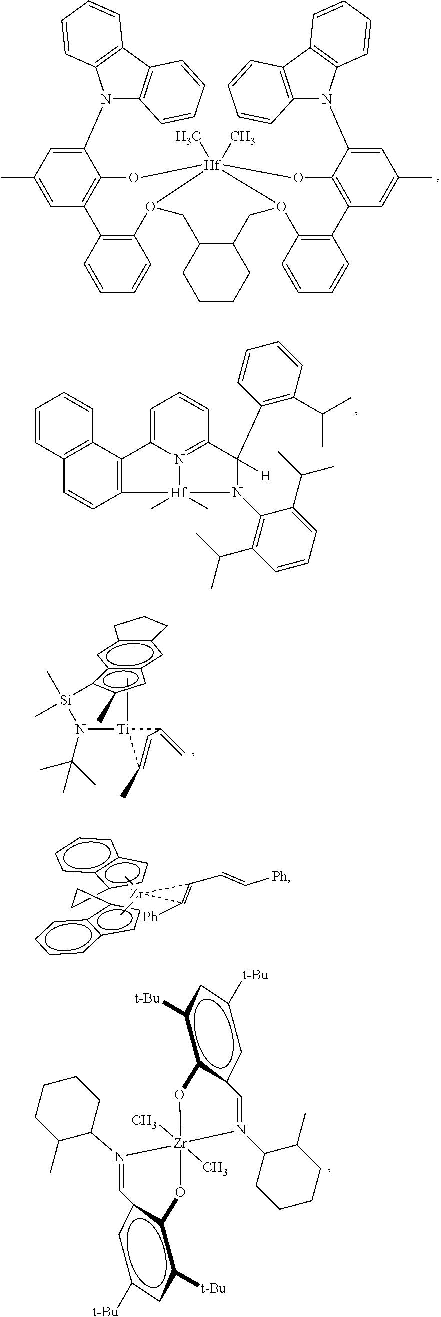

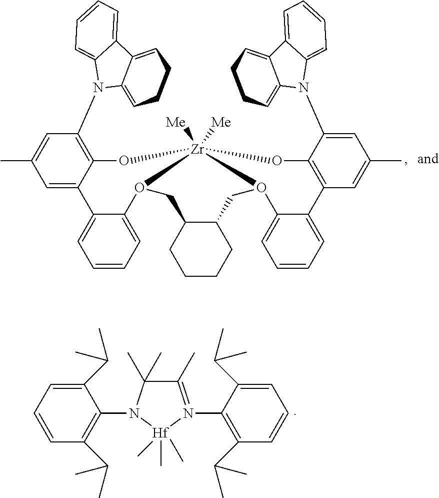

21. A reaction product of the process according to any one of claims 8-20.

22. An article produced from one or more reaction products according to claim 21.
